(19) United States
(12) Patent Application Publication
(10) Pub. No.: US 2010/0157114 A1
(43) Pub. Date: Jun. 24, 2010

(54) Method and Apparatus for Image Displaying

(76) Inventor: Yoshiyuki Niijima, Akishima-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/576,842

(22) Filed: Oct. 9, 2009

(30) Foreign Application Priority Data
Dec. 24, 2008 (JP) 2008-328076

(51) Int. Cl. H04N 9/64

(52) U.S. Cl. 348/246; 348/E09.037

(57) ABSTRACT

According to one of embodiments, an imaging apparatus to provide an imaging element which photoelectrically converts input information, a defective pixel detection module which detects a defective pixel included in the imaging element by each pixel output from the imaging element, and a defective pixel position storage module which detects that the defective pixel of the imaging element supplied from the defective pixel detection module is contiguous to an adjacent pixel, and stores the position of the defective pixel by 2-bit determination data and positional information of a first pixel when the defective pixel is contiguous.

### CROSS-REFERENCE TO RELATED APPLICATIONS

This application is based upon and claims the benefit of priority from Japanese Patent Application No. 2008-328076, filed Dec. 24, 2008, the entire contents of which are incorporated herein by reference.

### BACKGROUND

1. Field

One embodiment of the present invention relates to an imaging apparatus and signal processing method, which detect a defective pixel in a CCD sensor or CMOS image sensor, and corrects the influence of a defective pixel in an output image.

2. Description of the Related Art

An imaging apparatus, which adopts a charge-coupled device (CCD) sensor or complementary metal-oxide semiconductor (CMOS) as an imaging element, has been widely used. In a CCD sensor or CMOS image sensor known to be including a defective pixel from which a normal video signal cannot be obtained.

Under the circumstances, a method of storing positional information of a defective pixel and correcting the influence of a defective pixel when obtaining an output image has been proposed.

Japanese Patent Application Publication (KOKAI) No. 2007-228269 discloses an image signal processing apparatus, which corrects a defective pixel based on pixel information held by a holding means and pixel positional information synchronized with a video signal.

However, the publication describes holding positional information of a defective pixel, and correction of a defective pixel by using surrounding pixels, but does not describe a method of effectively holding positional information of defective pixels, that is, a method of decreasing a memory to store the positional information of defective pixels.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram of an imaging apparatus according to an embodiment of the invention;

FIG. 2 is a flowchart of a method detecting a defect of an imaging element of an image sensor of an imaging apparatus according to an embodiment of the invention; and

FIGS. 3A to 3D are diagrams each showing an example of a method of recording addresses of contiguous defective pixels at high density in an image sensor of the imaging apparatus according to an embodiment of the invention shown in FIG. 1.

### DETAILED DESCRIPTION

Various embodiments according to the invention will be described hereinafter with reference to the accompanying drawings. In general, according to one embodiment of the invention, an imaging apparatus to provide an imaging element which photoelectrically converts input information; a defective pixel detection module which detects a defective pixel included in the imaging element by each pixel output from the imaging element; and a defective pixel position storage module which detects that the defective pixel of the imaging element supplied from the defective pixel detection module is contiguous to an adjacent pixel, and stores the position of the defective pixel by 2-bit determination data and positional information of a first pixel when the defective pixel is contiguous.

Embodiments of this invention will now be described hereinafter in detail with reference to the accompanying drawings.

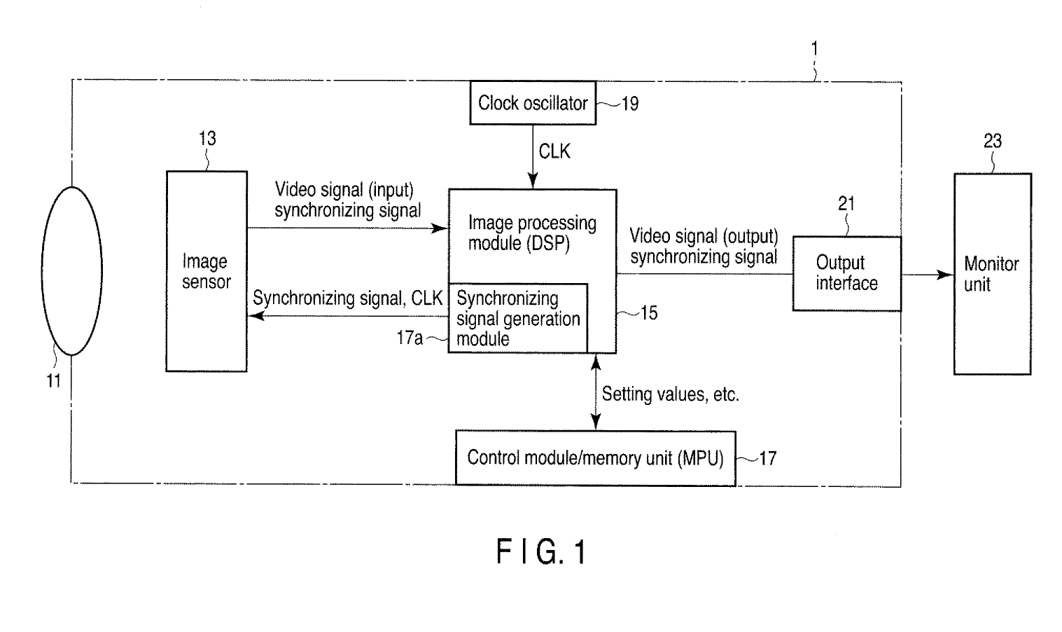

FIG. 1 shows an embodiment of an imaging apparatus according to the invention. In the following explanation, an element called a module may be realized either by hardware or software by means of a CPU, etc.

An imaging apparatus 1 shown in FIG. 1 includes a lens 11 which takes in the information about an imaging object as light-dark and color data of light, and an image sensor 13 which photoelectrically converts the information about an imaging object given predetermined optical characteristics by the lens 11, and outputs the converted information as brightness and color data. The image sensor 13 is a charge-coupled device (CCD) sensor or a complementary metal-oxide semiconductor (CMOS) image sensor, for example.

The image sensor 13 detects a defective pixel included in the image sensor 13 based on the brightness sor color data output from the image sensor 13, and inputs the detected defective pixel to an image processing module (DSP) 15 which corrects an output image corresponding to the defective pixel.

The position or address of the defective pixel obtained by the DSP 15 is stored according to a display of contiguous defect pixels to be explained later by using FIG. 3. When an output of image is requested, the MPU 17 demodulates the address of the defective pixel (from the display of contiguous defective pixels), and supplies the demodulated address to the DSP 15.

A clock oscillator (OSC) 19 supplies a clock signal CLK to the DSP 15. The DSP 15 includes a synchronization signal generation module (Sync) 17a as a part or as an independent unit.

An image output from the DSP 15 is applied as a visible image to a monitor unit 23, which is a liquid crystal display (LCD) panel or a cathode-ray tube (CRT), through an output interface (IF) 21.

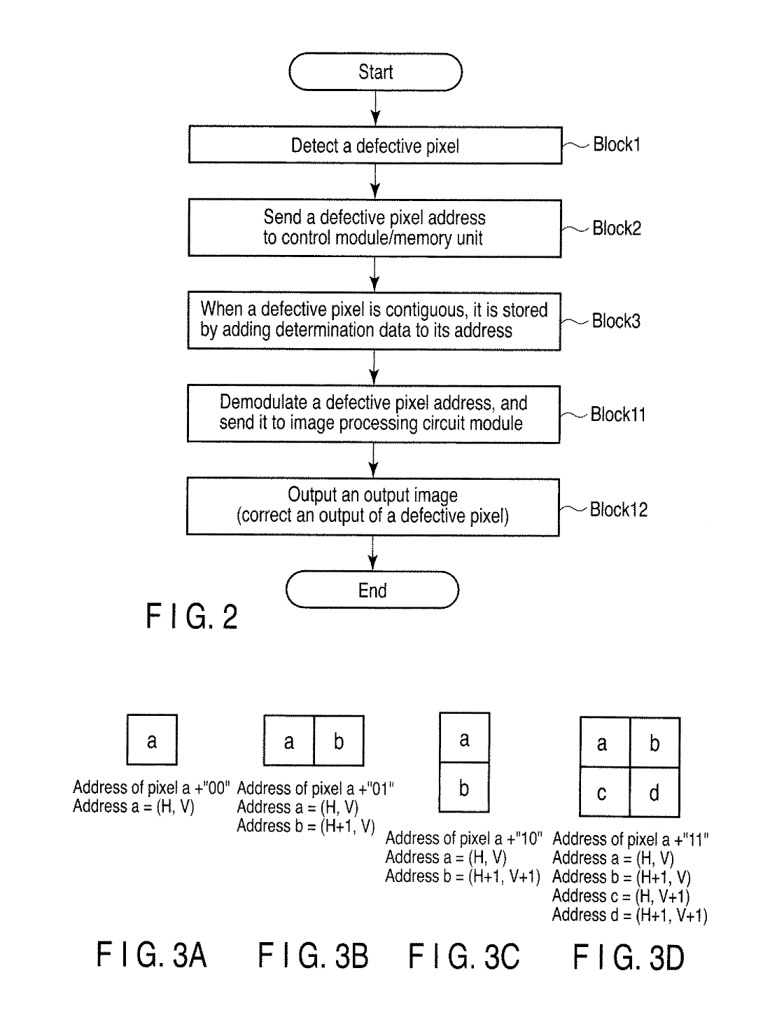

Specifically, when the imaging apparatus 1 is actuated, the DSP 15 checks whether each pixel of the image sensor 13 is defective, as shown in FIG. 2.

Namely, the DSP 15 checks each pixel output from the image sensor 13 (block 1).

For the pixel determined to be defective by the DSP 15, its address (positional information) is stored in the MPU 17. The address to be stored in the MPU 17 is sent from the DSP 15 to MPU 17 (block 2).

After the DSP 15 checks all pixels of the image sensor 13 for existence of defect, the MPU 17 checks whether a defect is contiguous based on the address of the defective pixel received from the DSP 15, or continuation of the defect (by scanning all addresses). When it can be confirmed that an optional number of defective pixels are contiguous, the contiguous defective pixels are stored according to a display of contiguous pixel defects by the method to be explained hereinafter by using FIGS. 3A to 3D.

On the other hand, when an image captured by the image sensor 13 is output, the MPU 17 sequentially sends the address of defective pixel. At this time, the contiguous defective pixels are demodulated to addresses of individual defective pixels according to the display of contiguous pixel defects to be explained in FIGS. 3A to 3D, and sent to the DSP 15 (block 11).

The DSP 15 corrects an image identified by the addresses of contiguous defective pixels or independent defective pixel, by using the outputs from the surrounding pixels (block 12).

FIGS. 3A to 3D show an example of a method of displaying addresses of contiguous defective pixels in which two or more defective pixels are contiguous. In the method of displaying contiguous defective pixels shown in FIGS. 3A to 3D, contiguous defective pixels are stored in the form of adding a 2-bit continuation (direction) determination flag to a representative pixel. The representative pixel indicates a vertical direction by V, and a horizontal direction by H. At this time, the continuation (direction) determination flag uses a memory area, which is used during detection of a defective pixel.

FIG. 3A shows a single (noncontiguous) defective pixel. In the example shown in FIG. 3A, only an independent pixel a is defective, and a continuation determination flag “00” is added in addition to the address (H, V) of pixel a, as a display of contiguous defect.

FIG. 3B shows contiguous defective pixels continuing in the horizontal direction. In the example shown in FIG. 3B, two defective pixels are continued in the horizontal direction, that is, a pixel b exists adjacent to the horizontal direction of pixel a. Thus, “01” is added in addition to the address (H, V) of pixel a as a representative pixel. At this time, the address of pixel b is (H+1, V).

FIG. 3C shows contiguous defective pixels continuing in the vertical direction. In the example shown in FIG. 3C, two defective pixels are continued in the vertical direction. Thus, “10” is added in addition to the address (H, V) of pixel a as a representative pixel. At this time, the address of pixel b is (H, V+1).

FIG. 3D shows contiguous defective pixels continuing in the vertical and horizontal directions. In the example shown in FIG. 3D, two defective pixels are continued in the vertical and horizontal directions, that is four (2×2) contiguous defective pixels. Thus, “11” is added in addition to the address (H, V) of pixel a as a representative pixel.

Considering four (2×2) matrixes whose sides are not adjacent to pixel a, the address of pixel d positioned on the diagonal line of pixel a can be expressed by (H+1, V+1). Since, the address of pixel b adjacent to the horizontal direction of pixel a is (H+1, V), and the address of pixel c adjacent to the vertical direction of pixel a is (H, V+1).

The DSP 15 outputs an image, that is, when the image captured by the image sensor 13 is reproduced, the MPU 17 outputs the address (H, V) of pixel a to the DSP 15 as an address of the single defective pixel shown in FIG. 3A.

The MPU 17 outputs the address (H+1, V) to the DSP 15, pixel a and pixel b adjacent to the horizontal direction of pixel a are determined to be defective, as shown in FIG. 3B.

Similarly, the MPU 17 outputs the address (H, V+1) to the DSP 15, pixel a and pixel b adjacent to the vertical direction of pixel a are determined to be defective, as shown in FIG. 3C.

When one pixel adjacent to the horizontal or vertical direction of a representative pixel (two contiguous pixels including a representative pixel) is a defective pixel as shown in FIGS. 35 and 3C, it is preferable to explicitly indicate that a pixel adjacent to which side of a representative pixel is defective.

Therefore, when the MPU 17 demodulates an address, the demodulation shall follow the rules of displaying contiguous defective pixels, that is, the address is (H+1, V) explained in FIG. 3B only when pixel b as a defective pixel is adjacent to the right side in the horizontal direction of pixel a as a representative pixel, and the address is (H, V+1) explained in FIG. 3C only when pixel b as a defective pixel is adjacent to the lower side in the vertical direction of pixel a as a representative pixel.

In the example shown in FIG. 3D, when pixel a as a representative pixel is sectionalized according to the definition of mathematical quadrants (when parallel coordinates are defined on a plane, of the four sections defined by the axes of coordinates, a section in which both x and y axes are positive is a first quadrant, a section in which x is negative and y is positive is a second quadrant, a section in which both x and y axes are negative is a third quadrant, and a section in which x is positive and y is negative is a fourth quadrant), it is confirmed that when pixel a is positioned in the second quadrant, pixel c is positioned in the third quadrant, pixel d is positioned in the fourth quadrant, and pixel b is positioned in the first quadrant. Therefore, when four (2×2) pixels are contiguous defects, pixel b is expressed by (H+1, V), pixel c is expressed by (H, V+1), and pixel d is expressed by (H+1, V+1).

Namely, the defective pixel address demodulated by the MPU 17 can be easily identified as an address (positional information) of a defective pixel to be corrected, based on the result received by the DSP 15.

When a 2-bit contiguous defective pixel determination flag is added to an address of the above described representative pixel, the number of displayable defective pixels is limited to four (2×2) at a maximum, but the MPU 17 can very easily demodulate an address of a defective pixel.

Further, four contiguous pixels including one non-defective pixel can be displayed as contiguous defective pixels by using the display of four (2×2) contiguous defective pixel shown in FIG. 3D. Namely, three defective pixels are substantially regarded as four (2×2) contiguous defective pixels, and the address is displayed (stored in the MPU 17), thereby the capacity of the memory to hold addresses of defective pixels can be decreased furthermore.

As explained herein, according to an embodiment of the invention, an address of a defective pixel included in an imaging element can be recorded at high densities. A recorded address of a defective pixel can easily be demodulated.

Therefore, it is possible to obtain an imaging apparatus which can record an address of a defective pixel without undesirably occupying a memory, and easily demodulate the address upon reproduction.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An imaging apparatus comprising:
an imaging element configured to convert input information, photoelectrically;
a defective pixel detection module configured to detect a defective pixel included in the imaging element by each pixel output from the imaging element; and
a defective pixel position storage module configured to detect that the defective pixel of the imaging element supplied from the defective pixel detection module is contiguous to an adjacent pixel, and configured to store the position of the defective pixel by 2-bit determination data and positional information of a first pixel when the defective pixel is contiguous.

2. The imaging apparatus of claim 1, wherein only when the defective pixel is contiguous, the defective pixel position storage module identifies, by the 2-bit determination data, two pixels of the first pixel and a pixel adjacent to the right side in the horizontal direction of the first pixel, two pixels of the first pixel and a pixel adjacent to the lower side in the vertical direction of the first pixel, and pixels contacting the pixel adjacent to the right side in the horizontal direction of the first pixel and contacting the pixel adjacent to the lower side in the vertical direction of the first pixel.

3. The imaging apparatus of claim 2, wherein the defective pixel position storage module is configured to display four defective pixels contiguous to first, third and fourth quadrants, when a first pixel of the defective pixel is positioned in a second quadrant according to the definition of mathematical quadrants.

4. The imaging apparatus of claim 1, wherein only when the defective pixel is contiguous, the defective pixel position storage module notifies the defective pixel detection module that the defective pixel is output in any one of states, two pixels of the first pixel and a pixel adjacent to the right side in the horizontal direction of the first pixel, two pixels of the first pixel and a pixel adjacent to the lower side in the vertical direction of the first pixel, and four pixels comprising pixels contacting the pixel adjacent to the right side in the horizontal direction of the first pixel and contacting the pixel adjacent to the lower side in the vertical direction of the first pixel.

5. The imaging apparatus of claim 4, wherein the defective pixel position storage module is configured to display four defective pixels contiguous to first, third and fourth quadrants, when a first pixel of the defective pixel is positioned in a second quadrant according to the definition of mathematical quadrants.

6. A signal processing method comprising:
detecting a defective pixel included in an imaging element by each pixel output from the imaging element;
detecting that the detected defective pixel of the imaging element is contiguous to an adjacent pixel; and
storing the position of the defective pixel by 2-bit determination data and positional information of a fist pixel when a defective pixel is contiguous.
